(19) United States
(12) Patent Application Publication
(10) Pub. No.: US 2017/0282831 A1
(43) Pub. Date: Oct. 5, 2017

(54) Method for producing a separation net and separation net

(71) Applicant: KKV MARKEN- UND PATENTSCHUTZ GBR, Solingen (DE)

(72) Inventors: Holger Vehring, Rhede (DE); Peter Stiefel, Seligenstadt (DE)

(73) Assignee: KKV MARKEN-UND PATENTSCHUTZ GBR, Solingen (DE)

(21) Appl. No.: 15/329,580

(22) PCT Filed: Aug. 10, 2015
(86) PCT No.: PCT/EP2015/068348

§ 371 Date: Feb. 17, 2017

(30) Foreign Application Priority Data
Aug. 25, 2014 (DE) 20 2014 103 950.3

(51) Int. Cl. B60R 21/06; D04B 21/10

(52) U.S. Cl. CPC B60R 21/06; D04B 21/10

(57) ABSTRACT

The invention relates to a method for producing a separation net and to a separation net (10), in particular for vehicle interiors, which has a net-like, tear-resistant textile web (11) formed of textile threads (12), which is cut to any peripheral contour, wherein the loose ends (13) of the textile threads (12) that were created by a separating cut are securely bound at the edges in a plastic material of a single-layered edge strip (18). The textile web (11) can have any peripheral contour, and the loose ends (13) of the textile threads (12) of the textile web (11) that were created by a cutting to size are embedded at least at the side edges (16, 17).

The invention relates to a method for producing a separation net and to a separation net, in particular for vehicle interiors, which has a net-like, tear-resistant textile web formed of textile threads, which is cut to a desired peripheral contour, wherein the loose ends of the textile threads that were created by a separating cut are securely bound at the edges.

In a known separation net according to EP 0 672 557 B1, after the punching out of a trapezoidal textile web, an edging made of a PVC film is provided, which is folded down around the punched edge and welded to the punched edge. The PVC film protects the loose ends of the textile threads of the textile web that were created by the punching from tearing out and securely binds them. In a separation net according to DE 101 28 104 C1, instead of the one folded down PVC strip, two edge strips of PVC are used, between which the net edge is inserted and welded. In the two previously known separation nets, the upper and lower outer edge is bound in this manner. In a separation net according to EP 112.5 800 B1 or DE 103 38 130 B4, such an edging by means of a PVC film, which is folded in a double layer over the punched edges and welded, is also provided for the side edges. In DE 103 38 130 B4, in the area of the upper and lower edges, an edge fastening made of compact warp-kitted fabric is formed. In addition to the expensive production of the above-mentioned separation nets, said separation nets have the disadvantage that the double-layered edge reinforcement by means of the PVC film results in thick outer edges. However, such thick outer edges are not problematic, since, when the separation net is rolled up on a winding shaft, they increase the size of the rolled-up package disadvantageously, which increases the space requirement for such a wound package. This is undesirable in a motor vehicle.

From the document EP 0 942 087 A2, a method is known for producing roller blinds. Here, in the production of the textile web, melt fibers are incorporated by weaving or warp-knitting. These melt fibers are molten and, after cooling and a corresponding cutting to size, they form a solidified outer edge. These outer edges, due to the incorporation of the melt fibers in the textile structure, namely as warp threads, as weft threads or as diagonal weft threads, are limited to this orientation. A textile web having any peripheral contour, in particular one having roundings or recesses, cannot be achieved in this way.

Therefore, the underlying aim of the invention is to provide a separation net—in particular for vehicle interiors—which does not have the disadvantages of the prior art and which can be produced cost effectively by a simple method, in particular by an industrial mass production process.

This aim is achieved with a method for producing a separation net having the features of claim 1 and with a separation net having the features of claim 10. The dependent claims describe advantageous embodiments.

The separation net according to the invention comprises, in a known manner, a net-like, tear-resistant textile web formed of textile threads, for example, a woven fabric or a warp-knitted fabric or a knitted fabric. This textile web is cut to any desired peripheral contour by means of a known cutting process, and the loose ends of the textile threads that were created by the separating cut are securely bound at the edges by an edging. In the manner, according to the invention, the edging of the loose ends of the textile threads of the textile web that were created by the cutting to size is achieved with a single-layered edge strip. This edge strip consists of a plastic material, in which the free ends of the textile threads are embedded. This single-layered edge strip can be achieved, for example, by molding the plastic material onto the textile web by spray application or by another thermal method in which the plastic material is softened, and the loose ends of the textile threads are bound by the soft, molten plastic material. After the cooling of the single-layered edge strip, the embedded loose ends of the textile threads are securely bound in these edge strips, namely embedded in the solidified plastic material. Here, the single-layered edge strip can encompass the textile web completely or only partially.

In a preferred manner, such an edging, namely the provision of this single-layered edge strip, occurs particularly on the straight or curved side edges. The side edges are normally the edges that were trimmed during the creation of the desired peripheral contour of a separation net. If during cutting to size, for example, in a known punching process, a trimming of the upper or lower outer edges or a cutting to size on the peripheral side also occurs, then these edge regions can be bound in the same manner by a single-layered edge strip. As a result of such a cutting to size, the separation net can have any peripheral contour with round edge regions and even with recesses in the contour, the loose ends in these edge regions as well are bound by the single-layered edge strip.

If such an edging, namely the formation of the single-layered edge strip, is created, for example, by an injection molding method, then this method also offers the possibility of achieving any three-dimensional edge geometry and any surface structure of the edge strip. This means that the edge strip can have, for example, a varying thickness along the peripheral contour of the separation net. Fastening elements can be created together with the edge strip, i.e., the edge strip is formed integrally with the fastening elements. The surface of the edge strip can be structured, for example, it can have relief, surface structure or a logo.

By the selection of the plastic, it is possible, in addition, to influence the stiffness of the edge strip. A stiff edge strip exists, for example, when a thermoplastic, such as polyamide, for example, is used, and a softer rollable edge strip is achieved, for example, by using an elastomer such as ethylene-propylene-diene elastomer (EPDM), for example.

The separation net according to the invention has the advantage that a separation net with a thin edging exists, so that, during the rolling up, a small package is formed. Advantageously, such a separation net having any desired peripheral contour can be produced, i.e., the textile web can have a rectangular or trapezoidal peripheral contour, or peripheral contour adapted, for example, to the shape of the vehicle interior. Such a separation net can be used both in a passenger car, for example, for partitioning the front interior from the rear interior, as well as for partitioning off a sleeping cabin in a truck or for partitioning an interior in a van.

In addition, such a separation net can advantageously be produced by a method, in particular by a manufacturing process that can be automated. Thus, for example, a textile web produced by weaving, warp-knitting or knitting can be led to a sizing step, where, in order to improve the properties, this textile web is coated with an appropriate sizing, for example, for solidifying the textile threads or for providing flame retardancy or for creating a coloring. Optionally, a thermal fixing takes place. Thereafter, in a known manner, a cutting to size of the textile web to any shape is carried out, for example, by punching or by cutting, for example, by laser cutting, by water jet cutting, hot cutting or by ultrasound or by another known cutting technology. This cutting to size can be carried out separately or also in a mold, in which the application by spraying, molding, pressing or the thermal binding in another manner of the plastic to the textile web occurs.

In a preferred embodiment, the binding at the edges is carried out by injection molding in an injection mold. One or more textile cuts are inserted into the injection mold, the mold is closed, and. after the closing of the injection mold, liquid plastic is sprayed onto these cuts at the edges. After the cooling, the separation net(s) obtained is/are removed from the injection mold. Here, the injection mold can be designed so that a desired edge geometry and surface structure of the edge strip are formed during the injection molding.

In another embodiment, the binding at the edges is carried out by hot pressing. A soft plastic composition and one or more textile cuts are introduced into a mold. When the mold is closed, due to pressure and temperature application, a melting of the soft plastic composition is achieved, which is applied at the edges to the textile cuts, and which then binds to them after the cooling. The separation nets obtained can be removed from the mold. In this method, as well, the mold can be designed so that a desired edge geometry and surface structure of the edge strip are formed.

For the separation net, a textile web made of thermally stable textile threads is used, in particular textile threads that remain unchanged in terms of their technical properties during the softening of the plastic material for the edge strips to the extent that, in the creation of the edge strip, no weakening at the edges of the net-like textile web occurs. It is preferable to use textile threads made of polypropylene (PP), polyamides (PA) and/or polyesters (PES).

For the plastic, thermoplastics or thermoplastic elastomers are used. The selection occurs depending on the desired stiffness of the edge strip to be formed. Preferably, thermoplastic elastomers are used as plastic for a soft edge strip. The plastic used has a corresponding long-term strength for the performance of the holding functions and at the same time good resilience so that the separation net with the plastic edge strips can be rolled up. In addition, for the use in a motor vehicle, a plastic with sufficient light fastness, thermostability, low emission values and low inflammability can be used.

Below, the invention is represented in reference to three embodiment examples and explained in further detail in reference to the drawings. The drawings show:

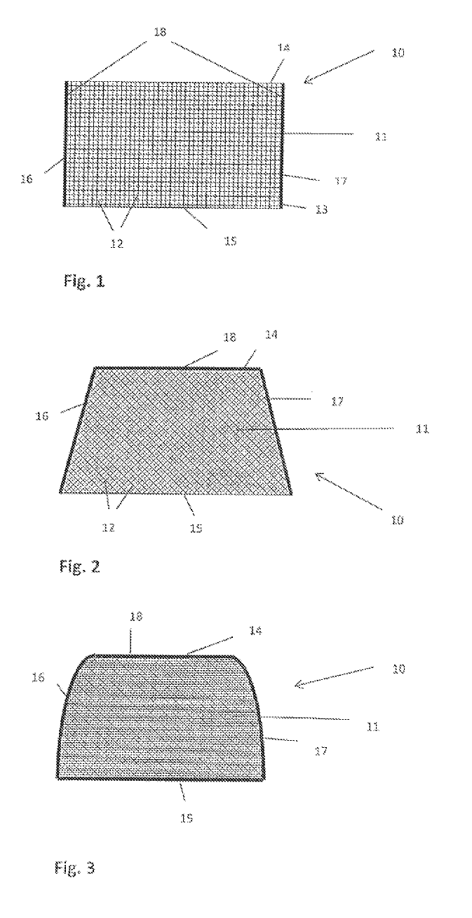

FIG. 1 a top view of a separation net according to the invention,

FIG. 2 a top view of another separation net,

FIG. 3 a top view of a third separation net.

The same reference numerals have been used for all the embodiments, even if the designs differ.

The separation net 10 shown in FIG. 1 comprises a net-like, tear-resistant rectangular textile web 11 formed of textile threads 12. Here, the web is a warp-knitted fabric in which the textile threads 12 form roughly square mesh openings.

For the creation of the desired peripheral contour, the textile web 11 was cut from a web of an already sized warp-knitted fabric, as a result of which, on the lateral, straight outer edges 16, 17, loose ends 13 were created on the textile threads 12 by the separating cut. The outer edges 16, 17 can also have any curved shape due to a corresponding separating cut. However, the loose ends 13 on the textile threads 12 are securely bound, namely by the plastic material of a single-layered edge strip 18, in which the ends 13 of the textile threads 12 are embedded. This lateral edge strip 18 produces a single-layered firmly bonded connection between the plastic material and the textile threads 12, without the strength of the textile web 11 being influenced. The loose ends 13 of the textile threads 12 are held securely in the plastic. Tearing out of the textile threads 12 is prevented by this finely bonded connection with the plastic material of the single-layered edge strip 18. In this example, PES/PA textile threads 12 were used.

FIG. 2 shows an additional embodiment of a separation net 10. This separation net 10 comprises a net-like, trapezoidal textile web 11, which also consists of a warp-knitted fabric. However, in this warp-knitted fabric, rhomboid mesh openings are provided. The trapezoidal peripheral contour was produced from the original warp-knitted fabric by a separating cut, namely on the side edges 16, 17 and on the upper outer edge 14. These cut edges are subsequently bound by a single-layered edge strip 18, and thereby the loose ends 13 of the textile threads 12 of the textile web 11 that were created by the cutting to size on the side edges 16, 17 and the upper outer edge 14 are embedded, firmly bonded, in the plastic material of the single-layered edge strip 18.

FIG. 3 shows an additional embodiment example. The separation net 10 according to the invention has a net-like textile web 11 with a peripheral contour that is adapted to the shape of the vehicle interior of a motor vehicle, so that the opening area between the vehicle walls and the separation net is reduced to a minimum, which ensures a good partitioning of the interior spaces. Depending on the design of the motor vehicle and the resulting different shape of the side walls and of the roof of the motor vehicle, fitting separation nets can be provided, which optionally also have recesses in course of the edge thereof. The textile web 11 in this case is a fabric. On all four outer edges 14, 15, 16, 17, a single-layered peripheral edge strip 18 made of plastic material is provided, which is connected, firmly bonded, to the textile threads 12 of the textile web.

The embodiments of a separation net 10 shown in the drawings are just a few examples for a separation net according to the invention. The invention is not limited to these embodiments. In addition to a net-like textile web 11 with square or rhomboid mesh openings, rectangular, honeycombed or other mesh openings are also possible. It is essential that the loose ends of the textile threads 12 that are created by a cutting of the textile web 11 to any shape are bound securely at the edges. The mesh openings of the textile web 11 can here be of equal or different size. In addition, the textile threads 12 of the textile web 11 can be designed to be uniformly black, white or also colored. In addition, in a known manner, the textile web can be provided with an appropriate sizing, depending on the application case, for example, with a flame-retardant coating or with a coating for solidifying the textile threads 12.

The separation nets 10 shown in the examples can be provided, in a known way, with fastening elements, for example, in the form of a hook, an eyelet or another form. On the upper outer edge 14, fastening elements can be provided for connecting to a metal holding rod and, on the lower outer edge 15, fastening elements can be provided for connecting to the winding shaft. Such fastening elements can also be formed directly integrally with the edge strips 18. On a lower outer edge 15, the edge strips 18 can be formed, for example, in the shape of a piping which can be pulled into a groove of the winding shaft.

### LIST OF REFERENCE NUMERALS

10 Separation net
11 Textile web
12 Textile threads
13 Loose ends
14 Outer edge, top
15 Outer edge, bottom
16, 17 Side edge
18 Edge strip

1. A method for producing a windable separation net for vehicle interiors, comprising:
producing a net-like, tear-resistant textile web,
sizing the textile web by coating with a sizing,
cutting the textile web to size to form textile cuts of any shape for separation nets, as a result of which free ends of the textile threads are created along a peripheral contour of any shape of the textile web,
binding these free ends of the textile threads of the textile cuts with plastic material in a thermal process step, so that the free ends of the textile threads are securely embedded in an edge strip formed from the plastic material,
wherein the connection at the edges is carried out by injection molding or hot pressing, wherein an injection mold or a mold for the hot pressing is designed so that a desired edge geometry and a desired surface structure of the edge strip can be achieved.

2. The method according to claim 1, characterized in that, after the closing of the injection mold, liquid plastic is applied at the edges to one or more textile cuts inserted into the injection mold, and, after the cooling, the separation net(s) obtained is/are removed from the injection mold.

3. The method according to claim 1, characterized in that one or more textile cuts are introduced into the mold used for hot pressing and a soft plastic composition is introduced at the edges, and, when the mold is closed, melting of the plastic composition by hot pressing and binding to the textile cuts occur, and, after the cooling, the separation net(s) obtained is/are removed from the mold.

4. The method according to claim 2, characterized in that, during the thermal binding, fastening elements are formed at the same time from the plastic, which become an integral component of the separation net, preferably of the edge strip of the separation net.

5. The method according to claim 1, characterized in that, in the thermal binding, a surface structure is introduced at the same time into the edge strip of the separation net to be formed, for example, in the form of relief, surface texture or a logo.

6. The method according to claim 1, characterized in that, in the thermal binding, edge strips are formed on the separation net, which have a varying thickness along the outer edges and transverse to the outer edges of the separation net.

7. The method according to claim 1, characterized in that the cutting to size occurs by punching or cutting, for example, by laser cutting, water jet cutting, hot cutting or ultrasound cutting.

8. The method according to claim 1, characterized in that the textile web is produced from thermally stable textile threads by weaving, warp-knitting or knitting.

9. The method according to claim 1, characterized in that, during the sizing, the textile web is colored and/or coated with a flame retardant.

10. A separation net for vehicle interiors produced according to claim 1, comprising a net-like, tear-resistant rollable textile web (11) formed from thermally stable textile threads (12), having any peripheral contour with outer edges (14, 15, 16, 17), wherein free ends (13) of the textile threads (12) are securely bound in an edge strip (18).

11. The separation net according to claim 10, characterized in that all the outer edges (14, 15) or only edge regions of the peripheral contour of the textile web (11) are embedded in a plastic material of a single-layered edge strip (18).

12. The separation net according to claim 10, characterized in that, on the edge strips (18), fastening elements are provided, which are formed integrally with the edge strips (18).

13. The separation net according to claim 10, characterized in that the edge strips (18) have any three-dimensional edge geometry and surface structure, preferably surface texture, relief or a logo.

14. The separation net according to claim 10, characterized in that the net-like textile web (11) is a woven fabric, a warp-knitted fabric or a knitted fabric, preferably a warp-knitted fabric.

15. The separation net according to claim 10, characterized in that the textile web (11) has rectangular, square, rhomboid or honeycombed mesh openings.

16. The separation net according to claim 10, characterized in that the textile web (11) has mesh openings of equal or different size, preferably in each case mesh openings of equal size.

17. (canceled)

18. The separation net according to claim 10, characterized in that the textile web (11) is bound by a soft edge strip (18) made of ethylene-propylene-diene elastomer (EPDM).

19. The separation net according to claim 10, characterized in that the textile web (11) is sized with a flame-retardant coating.

20. The separation net according to claim 10, characterized in that the textile threads (12) of the textile web (11) are colored.

21. (canceled)

22. The method of claim 1, further comprising: thermal fixing of the textile web after sizing the textile web and prior to cutting the textile web.
